(19) United States
(12) Patent Application Publication
(10) Pub. No.: US 2008/0024751 A1
(43) Pub. Date: Jan. 31, 2008

(54) Reticle holding member, reticle stage, exposure apparatus, projection-exposure method and device manufacturing method

(75) Inventor: Noriyuki Hirayanagi, Tokyo (JP)

Correspondence Address: KLARQUIST SPARKMAN, LLP, 121 SW SALMON STREET, SUITE 1600, PORTLAND, OR, 97204, US

(73) Assignee: Nikon Corporation

(21) Appl. No.: 11/827,371

(22) Filed: Jul. 10, 2007

(30) Foreign Application Priority Data
Jul. 11, 2006 (JP) 2006-190639

(51) Int. Cl. G03B 27/62

(52) U.S. Cl. 355/75

(57) ABSTRACT

Reticle-holding members are disclosed that prevent a reticle from falling from the reticle stage of an exposure device, even in event of a power failure, and that maintain flatness of the reticle surface on which the pattern is formed. In an exemplary configuration a reticle-holding member is configured to hold a reticle and is configured so that at least part of its edge portion projects beyond the reticle. The projecting edge portion is supported and mounted on the reticle stage of the exposure system.

### CROSS REFERENCE TO RELATED APPLICATION

This application claims priority to, and the benefit of, Japan Patent Application No. JP 2006-190639, filed on Jul. 11, 2006, incorporated herein in its entirety.

### TECHNICAL FIELD

This invention relates to reticle-holding members and to reticle stages including same. It also pertains to lithographic exposure systems, projection-exposure methods, and device-manufacturing methods using the reticle-holding member. More specifically, the invention relates to reticle-holding members that cover non-patterned portions of the reticle surface (portions on which a pattern is not formed), while holding the reticle. The invention also relates to reticle stages, exposure systems, projection-exposure methods, and device-manufacturing methods that use such reticle-holding members.

### BACKGROUND ART

In recent years, as semiconductor integrated circuits have become smaller, a projection-lithography technology has been developed that uses EUV (extreme ultraviolet) light with shorter wavelengths (11 to 14 nm, or more generally 5 to 50 nm) than the wavelength of conventional deep-ultraviolet light. The shorter wavelengths improve the resolving power of optical systems that otherwise are limited by the diffraction of light. This technology has most recently been called EUV (extreme ultraviolet) lithography and is expected to achieve pattern resolving powers of 70 nm or less. Such resolution is currently impossible to achieve in optical lithography using conventional deep-ultraviolet light having wavelengths of approximately 190 nm.

The complex index of refraction n of materials to light in the EUV wavelength range is expressed as n=1−δ−ik (in which i is a complex notation). The imaginary part k of the index of refraction expresses the absorption of extreme ultraviolet light. Because δ and k are very small relative to 1, the index of refraction of materials to light in the EUV region is very close to 1. Consequently, transmitting and refracting optical elements, such as conventional lenses, cannot be used with EUV wavelengths. Rather, optical systems using reflection must be used. Also, for lithography involving EUV, the reticle (also called a mask) is not a conventional transmitting reticle, but rather is a reflecting reticle.

To protect the patterned surface of the reticle (i.e., the surface on which the pattern is formed), whenever the reticle is being conveyed or the like, a protective cover may be mounted to the reticle. An example is discussed in, for example, U.S. Pat. No. 6,239,863, incorporated herein by reference in its entirety.

FIG. 9 shows a reticle 100 being conveyed on a reticle stage 201a by a conveying arm 301. The reticle 100 is mounted on the reticle stage 201a according to a conventional method involving electrostatic attraction of the reticle to a downward-facing surface of the reticle stage. Specifically, the reticle stage 201a comprises a downward-facing electrostatic chuck that produces an electric charge causing the reticle 100 to be electrostatically attracted to and held by the reticle stage 201a.

Conventionally, whenever electric power is not being supplied to the lithographic exposure system due to a power failure or the like, the reticle-attraction force produced by the electrostatic chuck drops substantially to zero; in the worst case, the reticle falls from the chuck.

In view of the foregoing, a need exists for devices that do not allow the reticle to fall from the reticle stage even during a power failure. Needs also exist for reticle stages, exposure systems, and exposure methods that involve use of such devices.

### SUMMARY

The needs expressed above are met by reticle-holding devices according to the present invention. A first embodiment of a reticle-holding member engages the non-patterned surface of the reticle (i.e., the reverse surface, on which a pattern is not formed, wherein the obverse surface of the reticle includes the pattern). The reticle-holding member includes an edge portion. At least one part of the edge portion projects beyond the edge of the reticle. The projecting edge portion of the reticle-holding member is supported and mounted on the reticle stage of the lithographic exposure system.

Another embodiment of a reticle-holding member is configured so that the reticle is not held on the reticle stage only by an electrostatic chuck. To such end, the reticle-holding member includes a projecting edge portion that is configured to be supported and mounted on the reticle stage of the exposure system. Consequently, the reticle is prevented from falling from the reticle stage even during a power failure.

A reticle detached from a reticle stage is vulnerable to contamination by foreign matter adhering to the reticle surface intended to contact, when electrostatically attracted to, the electrostatic chuck. If the reticle is contaminated in this manner, as the electrostatic chuck attracts the reticle, the foreign matter may be lodged between the reticle and the chuck, which can degrade the desired flatness (planarity) of the reticle surface on which the pattern is formed. Degrading reticle flatness adversely affects the resolution, pattern-alignment precision, and the like, of a projection-exposure system using the reticle.

Using a reticle-holding member according to the invention avoids mounting the reticle direction on the reticle stage. Thus, for example, the flatness of the reticle surface on which the pattern is formed can be maintained even if dust adheres to portions of the reticle surface on which the pattern is not formed.

The various embodiments of reticle-holding members that do not allow the reticle to fall from the reticle stage even during a power failure can be used in connection with reticle stages, exposure systems, and exposure methods.

### BRIEF DESCRIPTION OF THE DRAWINGS

FIG. 1 depicts orthogonal views of a first embodiment of a reticle-holding member.

FIG. 2 is an elevational view of the reticle-holding member of the first embodiment holding a reticle, wherein the reticle-holding member is mounted on a reticle stage of an exposure system.

FIG. 3 is an elevational view of a reticle-holding member, according to another embodiment, comprising an electrostatic chuck electrode that produces a reticle-attractive force.

FIG. 4 is an elevational view of a reticle-holding member, according to yet another embodiment, that comprises a pellicle and pellicle frame.

FIG. 5 is an elevational view depicting a reticle-holding member, according to yet another embodiment, that comprises a removable reticle cover.

FIG. 6 is a flow-chart of an embodiment of a projection-exposure method.

FIG. 7 is a perspective view showing an exemplary relationship between a reticle-holding member, a clean filter pod, and a reticle carrier.

FIG. 8 is a schematic elevational diagram depicting a configuration of an exemplary EUV exposure system.

FIG. 9 is an elevational view showing a reticle being conveyed on a reticle stage by a conveying arm to a reticle stage on which the reticle is subsequently mounted.

FIG. 10 is an elevational view depicting yet another embodiment of a reticle-holding member.

FIGS. 11(a)-11(b) are plan and perspective views, respectively, of an exemplary configuration of an end-effector, for conveying a reticle, and a supporting portion of a reticle stage.

FIG. 12 is a flow-chart of an exemplary microdevice-manufacturing process.

### DETAILED DESCRIPTION, INCLUDING BEST MODE

FIG. 8 shows the configuration of an exemplary EUV exposure system. An EUV light beam 32, emitted from an EUV light source 31, enters an illumination-optical system 33. In the illumination-optical system 33 the beam 32 is formed into a substantially parallel beam of light by a concave reflecting mirror 34 used as a collimating mirror. The beam then enters an optical integrator 35 comprising a pair of fly-eye mirrors 35a, 35b.

A substantially uniform and extended light source having a predetermined form is formed in the vicinity of the reflective surface of the fly-eye mirror 35a, specifically in the vicinity of the emission surface of the optical integrator 35. The light from the substantially uniform light source is deflected by the planar reflecting mirror 36 and forms a long and narrow arc-shaped illuminated region on the reticle R. (The figure does not show an aperture plate used for forming the arc-shaped illuminated region.) As the EUV light reflects from the patterned surface of the illuminated reticle R, the light is patterned accordingly and rendered capable of forming an image of the illuminated reticle pattern on the wafer W. The image is formed by a projection-optical system 37 that comprises a plurality of reflecting mirrors (in FIG. 8, six reflecting mirrors M1-M6 are shown for illustrative purposes.) The reticle R is held on a reticle stage (not shown), and the wafer W is held on a wafer stage (not shown). Thus, an image of the pattern on the surface of the reticle R is transferred to the wafer W.

The mirrors of the illumination-optical system and projection-optical system are contained in a vacuum chamber. Because EUV light is absorbed by air, the interior of the vacuum chamber must be maintained at high vacuum during use.

Respective reticles on which various patterns are formed are normally stored in a reticle storage (not shown) until time of use. For use, a particular reticle is removed from the reticle storage, conveyed to the exposure system, and mounted on the reticle stage of the exposure system. During conveyance of the reticle, the reticle must move from the atmospheric-pressure environment of the storage to a high-vacuum environment inside the exposure system. For movement of the reticle from atmospheric pressure to high vacuum, the reticle is placed in a load-lock chamber at atmospheric pressure. The atmosphere in the load-lock chamber is evacuated to high vacuum and the reticle is conveyed therefrom to inside the exposure system.

During storage at atmospheric pressure the reticle is normally contained in a double-storage device called a clean filter pod and reticle carrier. Also, to protect the reticle surface on which the pattern is formed, a pellicle may be mounted to the patterned surface (obverse surface) of the reticle.

Instead of using a clean filter pod, a reticle having a pellicle may be contained in a “vacuum pod” at high vacuum. The reticle with pellicle is placed inside the vacuum pod at atmospheric pressure, followed by evacuating the atmosphere in the pod to a high vacuum. The vacuum pod can then be conveyed into the vacuum chamber of the exposure apparatus, in which the reticle with pellicle is removed from the pod and placed on the reticle stage for exposure. After completion of exposure, the reticle with pellicle is conveyed from the reticle stage back to the vacuum pod, which meanwhile has been maintained at high vacuum, for storage. The interior of the vacuum pod is returned to atmospheric pressure usually only whenever the reticle with pellicle is to be removed from the vacuum pod to another location outside the exposure system. Hence, if the reticle is to be placed in or removed from the vacuum pod, the atmosphere inside the pod is changed from high vacuum to atmospheric pressure or from atmospheric pressure to high vacuum.

These changes in atmospheric pressure in the vacuum pod can cause fracture of the pellicle; hence, pressure changes in the vacuum pod are normally made slowly. Taking time to make pressure changes is normally not a problem because movement of the reticle into or out of the vacuum pod can be performed outside the exposure system, where the necessary time can be expended to perform slow pressure changes regardless of the operational status of the exposure system. If pressure changes are made slowly in this manner, the area of a filter or the like disposed on the pellicle rim can be minimized. In other words, since it is possible to reduce the rate at which the interior of the pod is evacuated to high vacuum or vented to atmospheric pressure, the required gaseous conductance and area of the filter associated with the pellicle can be relatively small. With reduction of filter area, the risk of foreign matter adhering to the filter is correspondingly reduced. An example of such a vacuum pod is a “vacuum clean box” as discussed in U.S. Pat. No. 6,136,168, incorporated herein by reference in its entirety.

Usually, the reticle is removed from a reticle carrier at atmospheric pressure and is removed from a clean filter pod in a high-vacuum environment. In the exposure system, the reticle is held by an electrostatic chuck associated with the reticle stage. The electrostatic chuck produces an electrostatic potential that causes the reticle to adhere to the chuck. The portions of the reticle that actually contact the chuck in this manner are regions that do not define any portion of the lithographic pattern.

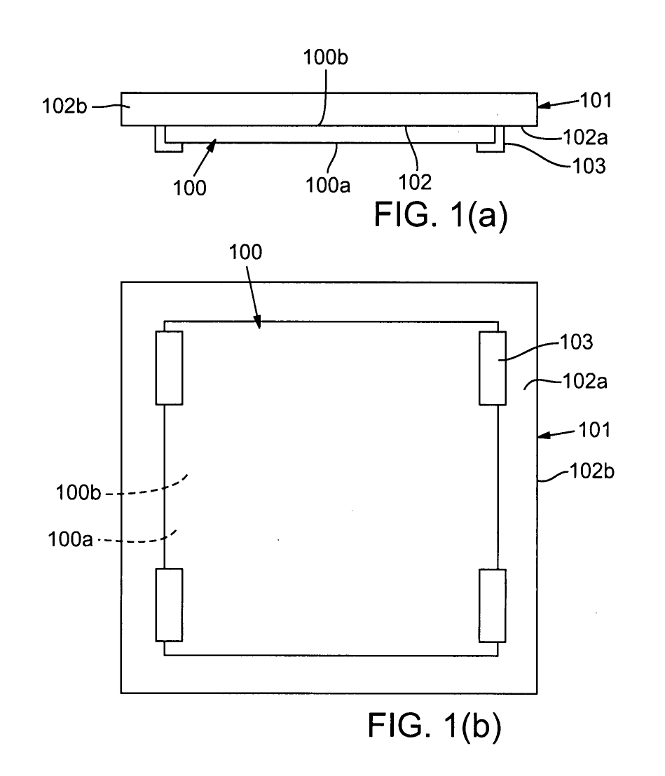

FIG. 1 shows a first embodiment of a reticle-holding member 101. The reticle-holding member 101 has an obverse surface 102. The reticle 100 is mounted to the obverse surface 102 in a manner such that the reverse surface 100b of the reticle (opposite to the patterned surface 100a of the reticle) contacts the obverse surface 102. The portion of the obverse surface 102 contacting the reticle 100 is termed the reticle-contact surface. In this embodiment, the obverse surface 102 has a wider profile than the reticle 100 and thus has a peripheral region 102a that extends beyond the reticle. The peripheral region 102a includes at least one projecting edge portion 102b.

In this embodiment the reticle-holding member 101 comprises at least one reticle presser 103 (four are shown) that mechanically contacts the reticle 100 in a clamp-like or clip-like manner. The reticle-holding member 101 can be formed of ceramic, low-thermal-expansion glass, or the like. In other words, low-thermal-expansion material can be used for the reticle-holding member. The reticle presser 103 can be formed of metal, plastic, or the like, and is affixed to the reticle-holding member 101. The reticle presser 103 is not limited to configurations that are simply mechanical in nature; other methods of reticle attachment thereby alternatively can be used. The reticle presser 103 desirably is configured to affix the reticle in a removable manner to the reticle-holding member 101. This allows the reticle 100 to be detached from the reticle-holding member 101 for cleaning or inspection.

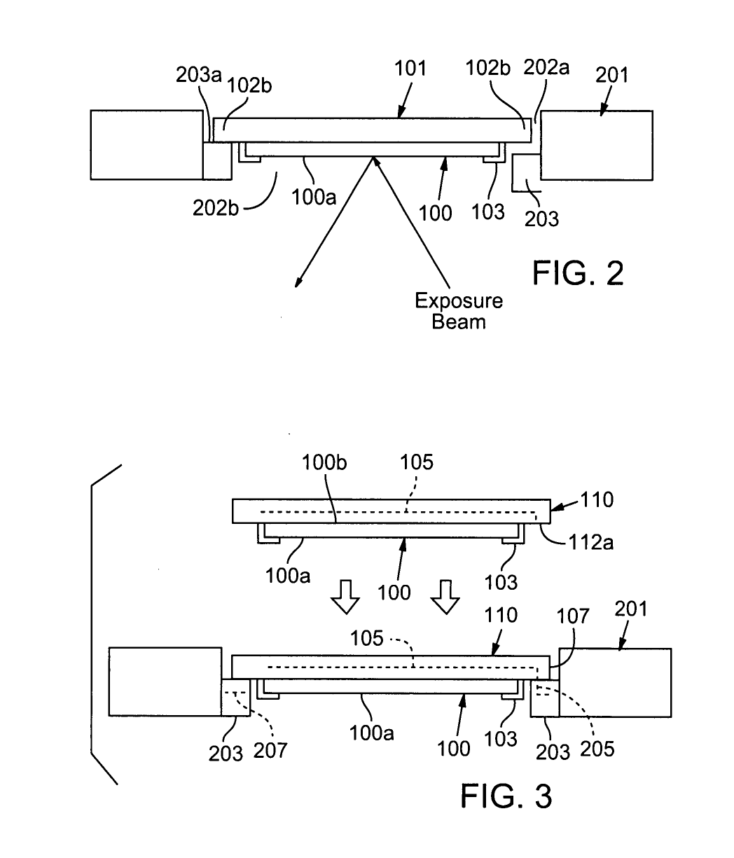

FIG. 2 shows a reticle-holding member 101 of the first embodiment mounted on the reticle stage 201 of an exposure system. Thus, the reticle 100 is held via the reticle-holding member 101 to the reticle stage 201. The reticle stage 201 defines a recess 202 or the like that receives the reticle-holding member 101. The recess 202 also defines an opening 202b in the radiation direction of the exposure beam. A supporting portion 203 is used for supporting the projecting-edge portion 102b of the reticle-holding member 101. Meanwhile, the reticle 100 is held in contact with the obverse surface 102 of the reticle-holding member 101 by the reticle pressers 103. This manner of holding the reticle 100 using the reticle-holding member 101 engaged with the supporting portion 203 prevents the reticle from falling from the reticle stage 201 in the event of a power failure to the exposure system. In other words, the obverse surface of the projecting edge portion 102b of the reticle-holding member 101 engages the upper surface 203a, relative to the direction of gravity, of the supporting portion 203. Meanwhile, the exposure beam is incident on the patterned obverse surface 100a (facing downward) to perform projection exposure.

FIG. 3 shows another embodiment of a reticle-holding member 110 that comprises an electrostatic chuck electrode 105 for producing an electrostatic force that attracts the reticle 100 to the obverse surface 112a of the reticle-holding member. During such attraction, contact of the reverse surface 100b of the reticle 100 with the obverse surface 112a of the reticle-holding member 110 is facilitated by the reticle pressers 103. Electrostatic attraction of the reticle 100 to the obverse surface 112a places substantially the entire reticle 100 in close contact with the obverse surface 112a, which improves the flatness (planarity) of the patterned obverse surface 100a of the reticle during use. Even when electrical power is not being supplied to the chuck electrode 105, the reticle 100 remains attached to the reticle-holding member 110 by the reticle pressers 103, which prevent the reticle 100 from falling or slipping from the reticle-holding member 110.

The chuck electrode 105 may be supplied with electrical power by a power feed 205 associated with the supporting portion 203 of the reticle stage 201. The power feed 205 conducts electrical current from the supporting portion 203 to the electrode 105.

In an alternative configuration, a battery (not shown) may be provided on or in the reticle-holding member 101a and used as a power source for the chuck electrode 105. Such a configuration would eliminate the need for the power feed 205. Thus, the reticle-holding member 110 can continue to hold the reticle 100 by electrostatic attraction in the event that electrical power is not or cannot be supplied from the supporting portion 203 of the reticle stage 201.

Also shown in FIG. 3 is a second electrostatic chuck electrode 207 used for affixing the reticle-holding member 110 to the supporting portion 203. The electrode 207 is located on or in the supporting portion 203. The peripheral region 112a (more specifically the projecting edge portion) of the reticle-holding member 110 is held to the supporting portion 203 by electrostatic force generated by the electrode 207. Thus, changes in relative positions of the reticle stage 201 and reticle-holding member 110 can be prevented, such as during motion of the reticle stage. The electrode 207 may alternatively be provided on the reticle-holding member 110 itself.

FIG. 10 shows a reticle-holding member 120 according to yet another embodiment. The reticle-holding member 120 is held by magnetic force to the supporting portion 223 of the reticle stage 201. The magnetic force is produced by a magnetic-field mechanism comprising a magnetic body 209. The magnetic body 209 is provided on or in the reticle-holding member 120, and a corresponding electromagnet 211 is situated on or in the supporting portion 223. The electromagnet 211 can be a coil, for example. The respective positions at which the magnetic body 209 and electromagnet 211 are disposed can be as shown in FIG. 10; alternatively, the magnetic body 209 and electromagnet 211 may be disposed so as to surround the reticle 100 in a ring-like manner, or may be disposed only at predetermined locations (three points, for example) around the reticle. Further alternatively, the magnetic body 209 may be disposed on or in the supporting portion 223, while the electromagnet 211 is disposed on or in the reticle-holding member 120. The source of electrical current to the electromagnet 211 (serving as a magnetic-field-generating means) is not shown, but its disposition is obvious to a person of ordinary skill in the art.

Compared to an electrostatic-attraction mechanism, the magnetic-attraction mechanism such as described above in connection with FIG. 10 can provide good breakaway responsiveness to the body being held. In other words, it is possible to detach the reticle-holding member 120 from the supporting portion 223 relatively quickly by simply stopping flow of electrical current to the electromagnet 211. Thus, the time necessary for reticle exchange is reduced, and the throughput of the exposure system is correspondingly increased. In this alternative embodiment, the reticle 100 is still held by electrostatic attraction to the reticle-holding portion 120. Consequently, in many respects, this embodiment is similar to the embodiment shown in FIG. 3.

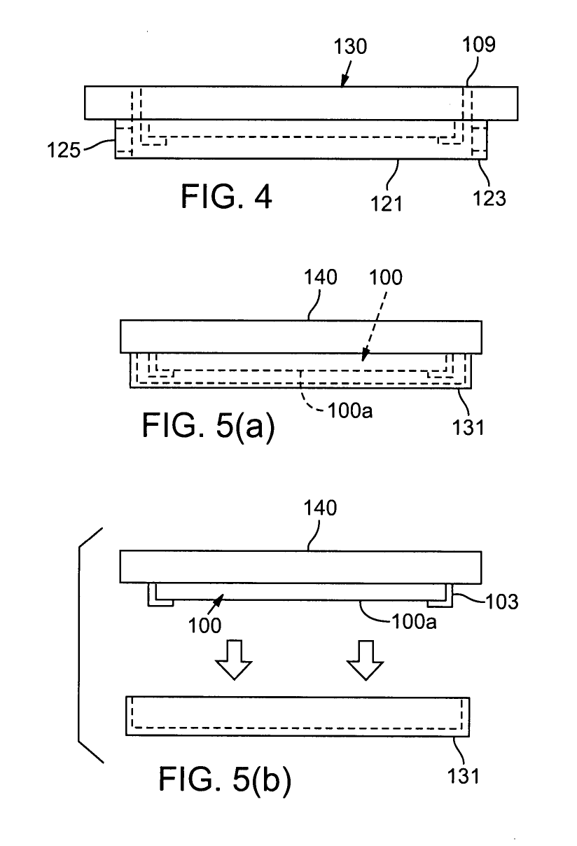

FIG. 4 depicts a reticle-holding member 130 configured to allow removal of a pellicle frame 123 of a pellicle 121. The pellicle frame 123 may be removably attached to the reticle-holding member 130 using a magnet, clamps, clips, or the like. As known in the art, a “pellicle” is a dust-proofing thin film used for protecting the reticle surface on which the pattern is formed. Since the pellicle is a thin film, it is easily broken by application of a pressure differential across it, such as whenever the reticle-holding member 130 is being “moved” from an atmospheric-pressure environment to a high-vacuum environment, or vice versa. To prevent breaking the pellicle, a filter 125 is situated on the pellicle frame 123 to alleviate pressure differentials across the pellicle 121. The filter 125 normally has low gaseous conductance to prevent the passage therethrough of finely particulate foreign matter. Consequently, during use of the filter 125 of the pellicle frame 123, cases can arise in which the pressure differential on both sides of the pellicle is not sufficiently alleviated or not alleviated sufficiently rapidly. In such a case, as shown in FIG. 4, the pressure differential on both sides of the pellicle can be further alleviated by providing a similar filter 109 on the reticle-holding member 130 as well.

FIG. 5 depicts yet another embodiment of a reticle-holding member 140, which comprises a removably mounted cover 131. The cover 131 protects the obverse (patterned) surface 100 of the reticle 100 whenever the reticle 100 is not being used. The cover 131 is removed from the reticle 100 whenever the reticle is being used for exposure. The cover 131 may be mounted on the reticle-holding member 140 using a magnet, clamps, clips, or the like. An example of a removable cover is discussed in U.S. Patent Application Publication No. 2006-0087638, incorporated by reference herein in its entirety.

In this embodiment, the cover 131 is mounted on the reticle-holding member 140 and not directly on the reticle 100. Consequently, the cover 131 can be attached and removed without touching the reticle 100, and generation of foreign matter, that otherwise would be caused by the cover 131 touching the reticle 100, is prevented. The cover 131 can be removed before or after the reticle 100 is placed on the reticle stage. During exposure, the exposure beam illuminates the reticle 100 after the cover 131 has been removed. Upon completing exposure, the reticle 100 is covered again with the cover 131. Thus, whenever the reticle 100 is being affixed to the reticle stage or being removed from the reticle stage, the patterned surface of the reticle is protected by the cover 131.

FIG. 8 depicts an embodiment of an exposure system. Although certain details are not shown in FIG. 8, it will be understood that the reticle stage 201 in this system comprises a recess configured to receive the reticle-holding member 150 while providing an opening in the radiation direction of the exposure beam. The reticle stage 201 also comprises a supporting portion 203 that supports the projecting-edge portion of the reticle-holding member 150, in the manner shown for example in FIGS. 2 and 3.

In this embodiment of an exposure system, the reticle 100 does not fall from the reticle stage 201 even in the event of a power failure. Consequently, system throughput is improved. Also, the flatness (planarity) of the reticle surface, on which the pattern is formed, is not impaired by foreign matter that may become lodged between the reticle stage and the back side of the reticle. Hence, the high resolution of the exposure system is maintained.

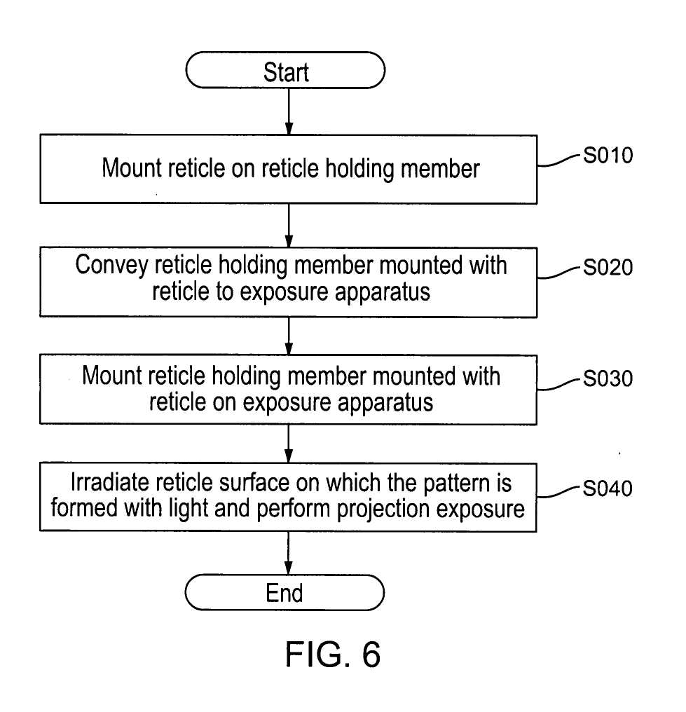

FIG. 6 is a flow-chart of an embodiment of a projection-exposure method. In step S010 in FIG. 6, the reticle is mounted on the reticle-holding member. For example, as shown in FIG. 1, the reticle 100 is secured by the reticle pressers 103 to the obverse surface 102 of the reticle-holding member 101. In step S020 the reticle-holding member, on which the reticle is mounted, is conveyed to the exposure system.

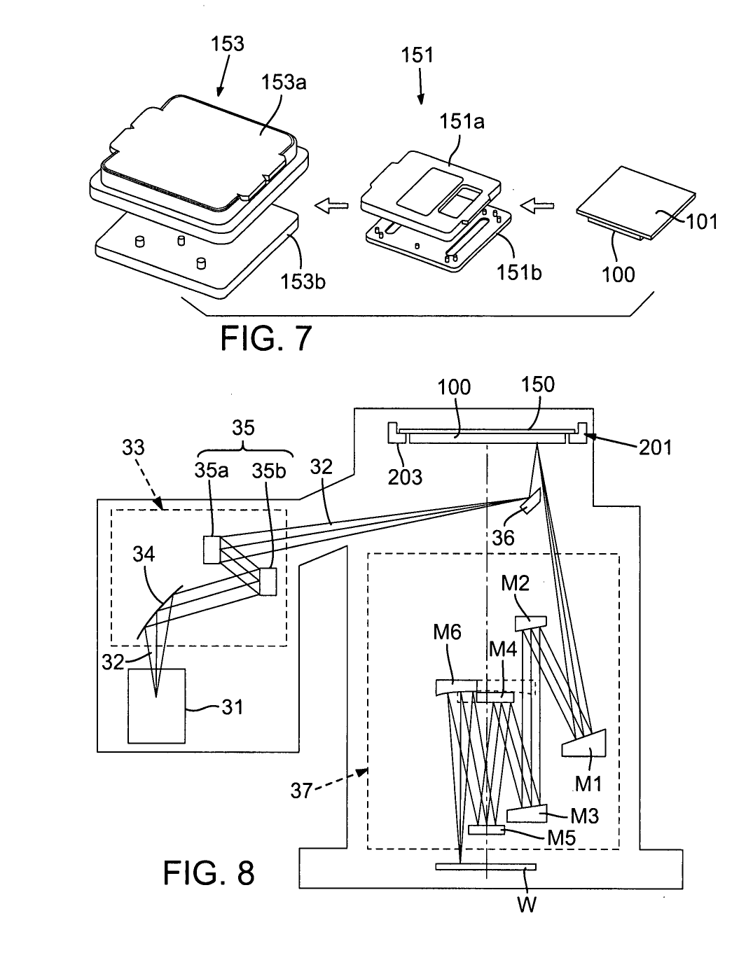

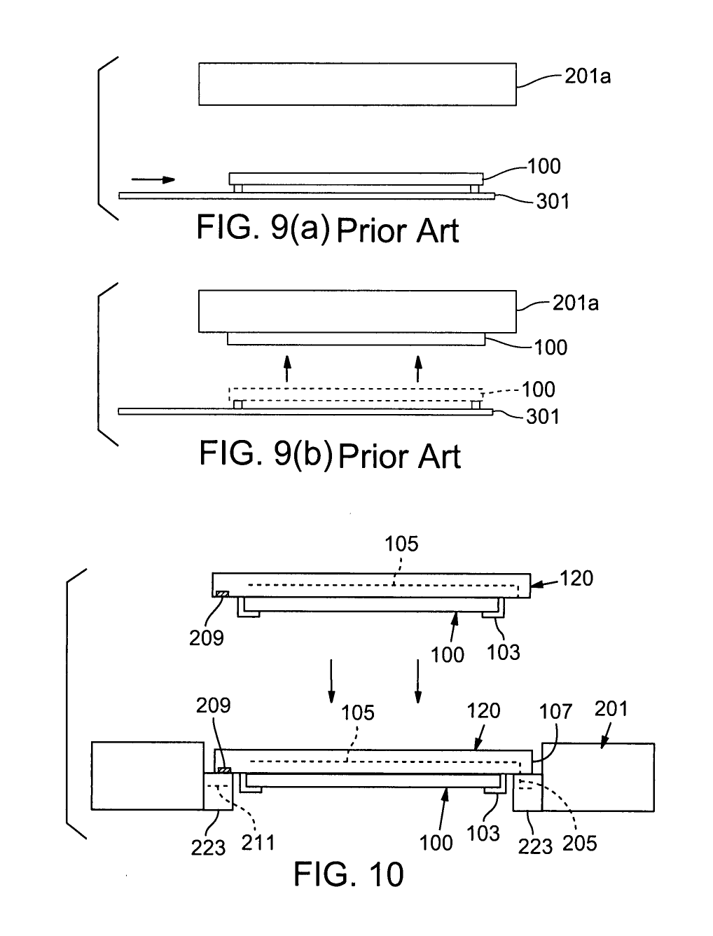

FIG. 7 shows an exemplary relationship between a reticle-holding member 101, a clean filter pod or reticle cover 151, and a reticle carrier 153. The reticle-holding member 101, on which the reticle 100 is mounted, may be contained initially within the clean filter pod 151 (comprising top cover 151a and bottom cover 151b). The reticle-holding member 101 and reticle 100 are then contained and conveyed within the reticle carrier 153 (comprising cover 153a and base 153b). During movement of the reticle-holding member 101 (to which the reticle 100 is mounted) to the reticle stage of the exposure system for use in exposure, they are removed from the reticle carrier 153 and clean filter pod 151.

In step S030 in FIG. 6, the reticle-holding member (holding the reticle) is mounted on the reticle stage of the exposure system. The manner of this mounting has already been described in connection with the examples shown in FIGS. 2 and 3. Although not shown in FIGS. 2 and 3, it is possible that the end-effector of the robot conveying the reticle may strike the reticle stage during placement of the reticle. To prevent such an event, it is desirable to provide one or more grooves or voids in the reticle stage so that the end-effector does not strike the reticle stage. It is also desirable to use a special-purpose device for mounting the reticle on the reticle stage.

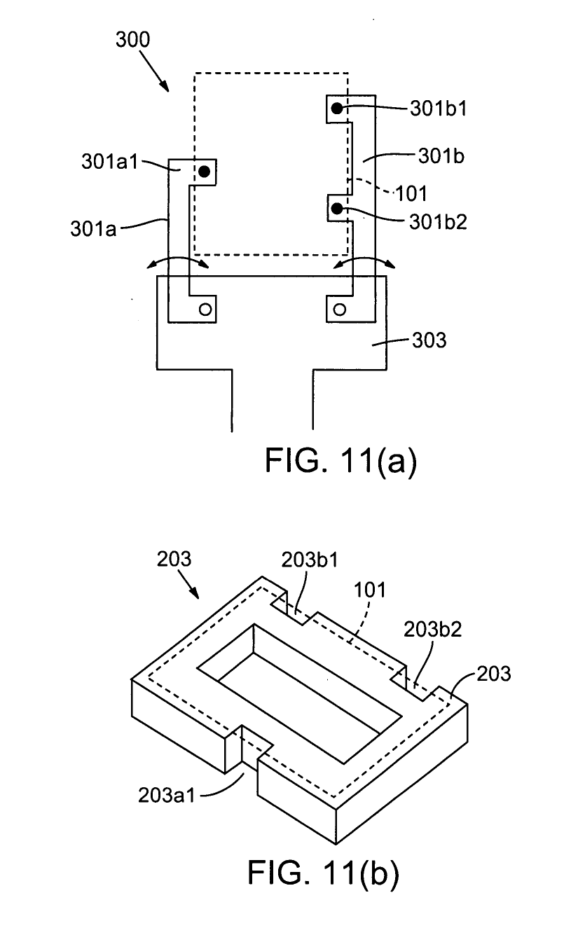

FIGS. 11(a)-11(b) depict an exemplary configuration of such an end-effector 300, for conveying the reticle, and the supporting portion 203 of the reticle stage 201. In FIG. 11(a) the end-effector 300 comprises two conveying arms 301a and 301b and a base portion 303 to which the two conveying arms are rotatably affixed. The conveying arms 301a, 301b provide three supporting portions 301a1, 301b1, 301b2. The reticle-holding member 101, shown by the dashed line, is supported on these supporting portions. Attraction means, such as electrostatic-attraction means or the like, may be disposed on the supporting portions 301a1, 301b1, 301b2 to facilitate holding of the reticle-holding member 101. On the supporting portion 203 of the reticle stage 201, notches 203a1, 203b1, 203b2 are defined (FIG. 11(b)) so that the three supporting portions 301a1, 301b1, 301b2 do not mechanically interfere with the reticle stage when the reticle-holding member 101 is being loaded on the stage. Upon loading the reticle-holding member 101 on the supporting portions, the reticle-holding member 101 is conveyed to the reticle stage 201. By moving the end-effector 300 downward (or the reticle stage upward), the three supporting portions 301a1, 301b1, 301b2 enter the respective notches 203a1, 203b1, 203b2. Thereafter, the two conveying arms 301a, 301b pivot outwardly from the reticle-holding member 101, and the end-effector 300 moves upward. Meanwhile, the three supporting portions 301a1, 301b1, 301b2 do not mechanically interfere with the reticle-holding member 101. Thus, the reticle 100 affixed to the reticle-holding member 101 is loaded on the reticle stage 201. Removal of the reticle 100 from the reticle stage 201 is performed by reversing the procedure described above.

In alternative embodiments the end-effector 300 may be configured to comprise a plurality (four, for example) of conveying arms that can load a plurality of reticles.

In step S040 in FIG. 6, the obverse surface of the reticle 100, on which the pattern is formed, is irradiated, and projection-exposure is performed. Upon completion of exposure using the reticle, the reticle need not be detached from the reticle-holding member every time if cleaning and/or inspection of the reticle are not necessary. If another reticle is now used for exposure, the reticle on the reticle-holding member can be sidelined in a vacuum environment or atmospheric-pressure environment. The next time that particular reticle is used, the procedure can be performed from step S020 in FIG. 6.

With the projection-exposure method according to this embodiment, the reticle does not fall from the reticle stage even in the event of a power failure. Consequently, system throughput is improved. Furthermore, the flatness of the reticle surface, on which the pattern is formed, is not impaired if foreign matter should become lodged between the reticle stage and the back side of the reticle; hence, the high resolution of the exposure system is maintained.

In some embodiments the reticle-holding member is configured to cover the entire reverse surface (back-side) of the reticle 100. In other embodiments the reticle-holding member is configured to cover only a portion of the reverse surface of the reticle. In various alternative embodiments, the electrostatic chuck electrode can be disposed only on portion(s) covering the back-side of the reticle. If it is unnecessary to affix the reticle from its back-side, the reticle-holding member need not be disposed on the back-side of the reticle, and the reticle-holding member can be disposed in the form of a rim on only the side portion of the reticle.

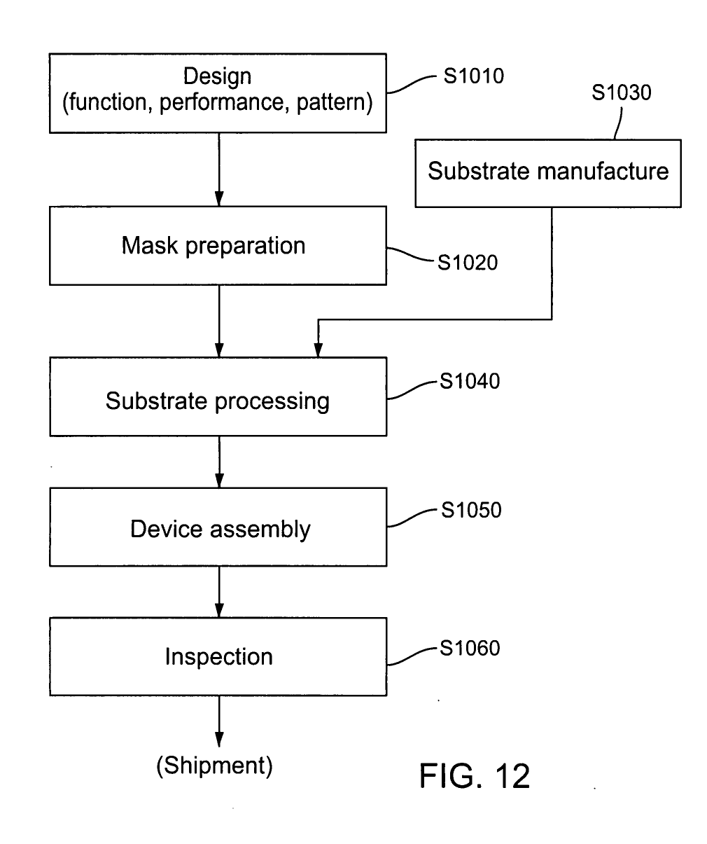

FIG. 12 is a flow-chart of an exemplary microdevice-manufacturing process. In step S1010 the functions and performance of the microdevice are designed. In step S1020 the mask (reticle) is prepared based on the design results obtained in step S1010. In step S1030 the substrate serving as the base material of the device is manufactured. In step S1040 substrate processing is performed. According to the embodiments described above, substrate-processing includes exposure of the substrate with an exposure beam via a reticle, and includes development of the exposed substrate. In step S1050 the microdevice is assembled. Microdevice assembly includes finishing processes such as a dicing process, a bonding process, a packaging process, and the like. In step S1060 microdevice inspection is performed.

What is claimed is:

1. A device for holding a reticle having an obverse surface, a reverse surface, and a peripheral edge, the device comprising:
a first surface comprising a reticle-contact surface and a peripheral region, wherein at least a portion of the peripheral region comprises a projecting edge portion; and
an attachment device arranged relative to the first surface and the reticle so as to hold at least a portion of the reverse surface of the reticle in contact with the reticle-contact surface;
the projecting edge portion being configured to extend, relative to the reticle being held, from the peripheral edge of the reticle and to be received by a reticle stage of an exposure system upon placement of the reticle on the reticle stage.

2. The device of claim 1, wherein the reticle-contact surface is substantially planar.

3. The device of claim 1, configured to hold the reticle during storage of the reticle, conveyance of the reticle, and mounting of the reticle to the reticle stage.

4. The device of claim 1, configured so that, of the first surface, the projecting edge portion is situated to contact the reticle stage as the device is mounted to the reticle stage.

5. The device of claim 1, wherein the attachment device comprises at least one reticle presser.

6. The device of claim 5, wherein the reticle presser is configured to hold the reticle in a removable manner.

7. The device of claim 1, wherein:
the obverse surface of the reticle includes a patterned region and a non-patterned region; and
the reticle-holding device holding a reticle covers at least a portion of the non-patterned region.

8. The device of claim 1, wherein:
the reticle is a reflective reticle, of which the obverse surface is reflective; and
the reticle-holding device holding a reticle covers at least a portion of the reverse surface of the reticle.

9. The device of claim 8, wherein:
the obverse surface of the reticle includes a patterned region; and
the reticle-holding device holding a reticle covers at least the reverse surface of the reticle opposite the patterned region.

10. The device of claim 8, wherein:
the obverse surface of the reticle includes a patterned region and a non-patterned region; and
the reticle-holding device holding a reticle covers substantially the entire non-patterned region.

11. The device of claim 1, wherein the attachment device comprises a reticle-attracting device.

12. The device of claim 11, wherein the reticle-attraction device comprises:
an electrostatic electrode; and
an electrical contact from the reticle stage to the electrostatic electrode, the contact being configured to conduct electrical current from the reticle stage to the electrode to provide the electrode with an electrical potential.

13. The device of claim 11, wherein the reticle-attraction device comprises:
an electrostatic electrode; and
a battery connected to the electrode to provide the electrode with an electrical potential.

14. The device of claim 1, wherein:
the reticle includes a pellicle mounted on a pellicle frame; and
the reticle-holding device is configured to hold the reticle with the pellicle frame attached to the reticle.

15. The device of claim 14, wherein the pellicle frame further comprises a filter configured to allow alleviation of a pressure differential across the pellicle.

16. The device of claim 1, wherein:
the obverse surface of the reticle includes a patterned surface; and
the reticle-holding device further includes a cover-application device configured, when the reticle is not being used for an exposure, to place the reticle relative to a cover configured to cover at least the patterned surface.

17. A device for holding a reticle having an obverse surface, a reverse surface, and a peripheral edge, the device comprising:
a reticle-holding member having a first surface comprising a reticle-contact surface and a peripheral region, wherein at least a portion of the peripheral region comprises a projecting edge portion that is configured to extend, relative to the reticle being held, from the peripheral edge of the reticle; and
a reticle stage including a supporting portion;
the supporting portion being configured to receive the projecting edge portion to support the reticle being placed on the reticle stage.

18. The device of claim 17, wherein:
the obverse surface of the reticle includes a patterned region;
the reticle stage defines a void that reveals, whenever the reticle is being held by the reticle stage, the patterned region that is open in a radiation direction of an exposure beam incident on the patterned region.

19. The device of claim 17, wherein the supporting portion comprises a reticle-attraction device situated and configured to attract the peripheral region of the reticle-holding member.

20. The device of claim 17, wherein the reticle-attraction device comprises a magnetic-field-generating device that generates a magnetic field attracting the peripheral region.

21. An exposure system, comprising a device as recited in claim 17 and being configured to perform projection exposure of a pattern defined by a reticle being held by the reticle-holding device.

22. An exposure system, comprising:
a reticle stage;
a reticle-holding device as recited in claim 12; and
a voltage-application device for applying voltage to the electrical contact to cause the electrode to attract the projecting-edge portion to attract the reticle-holding device to the reticle stage and thus hold the reticle during exposure of a pattern defined by the reticle.

23. A projection-exposure method, comprising:
mounting a reticle on a reticle-holding device as recited in claim 1;
conveying the reticle-holding device, on which is mounted the reticle, to an exposure system;
mounting the reticle-holding device, on which the reticle is mounted, on a reticle stage of the exposure system; and
irradiating a pattern, defined by the reticle, with an exposure light to perform projection-exposure of the pattern.

24. A device-manufacturing method, comprising:
exposing a substrate using the exposure method recited in claim 23; and
developing the substrate.
